(19) United States
(12) Patent Application Publication
(10) Pub. No.: US 2015/0148715 A1
(43) Pub. Date: May 28, 2015

(54) DEVICE FOR PASSIVE BODY MOBILIZATION

(71) Applicant: Paulo Sergio BERVIAN, Doungguan City (CN)

(72) Inventor: Paulo Sergio BERVIAN, Doungguan City (CN)

(21) Appl. No.: 14/087,622

(22) Filed: Nov. 22, 2013

(51) Int. Cl. A61H 1/02

(52) U.S. Cl. CPC A61H 1/02; A61H 2201/1664; A61H 2201/5007
USPC 601/26

(57) ABSTRACT

A device for passive body mobilization is described which allows the body to be stretched out and the body's axis to be moved, inducing the lateral flexion and extension of the abdomen by means of a movable platform (20) that performs a horizontal movement between the sides of the base (10) as a result of the action of a frequency inverter.

### FIELD OF THE INVENTION

The present invention concerns a passive body mobilization device. More specifically, it comprises a device that allows the body to be stretched out and the body's axis to be moved, inducing the lateral flexion and extension of the abdomen.

### BACKGROUND OF THE INVENTION

Humans have approximately 639 muscles. Each muscle has its motor nerve, which is divided into several fibers to be able to control all muscle cells, through the motor endplate.

Muscles are active organs for moving. They are provided with the ability of contracting and relaxing and, thus, they transmit their motions to the bones to which they are attached, which form the passive system of the locomotor apparatus.

The body's movement, with the displacement of the body's axis, offers stimuli inducing the functions related to the middle and low burners of the human body, according to Chinese Traditional Medicine, through induced mobility and delivery conditioning to whom is subjected to this device.

### SUMMARY

The invention provides a device for passive body mobilization that produces lateral flexion and extension movements simultaneously (crawling simulation) of the thoracicolumbar region.

The invention provides a device for passive body mobilization that provides as outcome weight loss and toning of the waist region (abdominal and lumbar muscles).

The invention provides a device for passive body mobilization that provides relaxation of lumbar tensions, as it is a passive activity, without impact and without joint compression.

The invention provides a device for passive body mobilization that provides improvement of organic functions related to the region being worked and activates the circulation of the small bowel and enhances the function of nutrient absorption, facilitates the peristaltic movement of the large bowel, livens the intestinal flora, helps in the process against constipation and hemorrhoids, activates the circulation of the genital region.

The invention provides a device for passive body mobilization that allows exercises to be performed without physical effort, resistance and requirement of psychomotor control.

The invention provides a device for passive body mobilization that provides a greater reason for preserving the articular bodies and the results of their impact as movements are performed horizontally.

### BRIEF DESCRIPTION OF FIGURES

FIG. 1 shows a perspective view of the device.

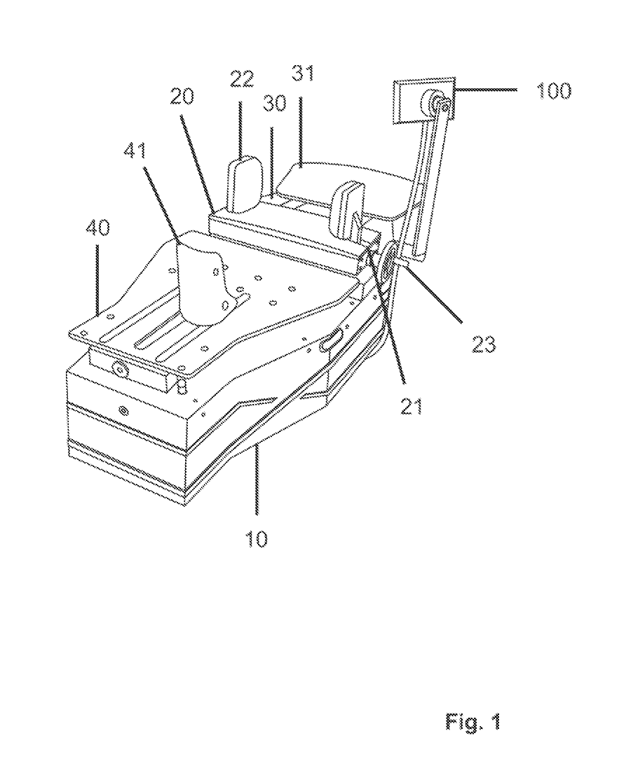

FIG. 2 shows a side view.

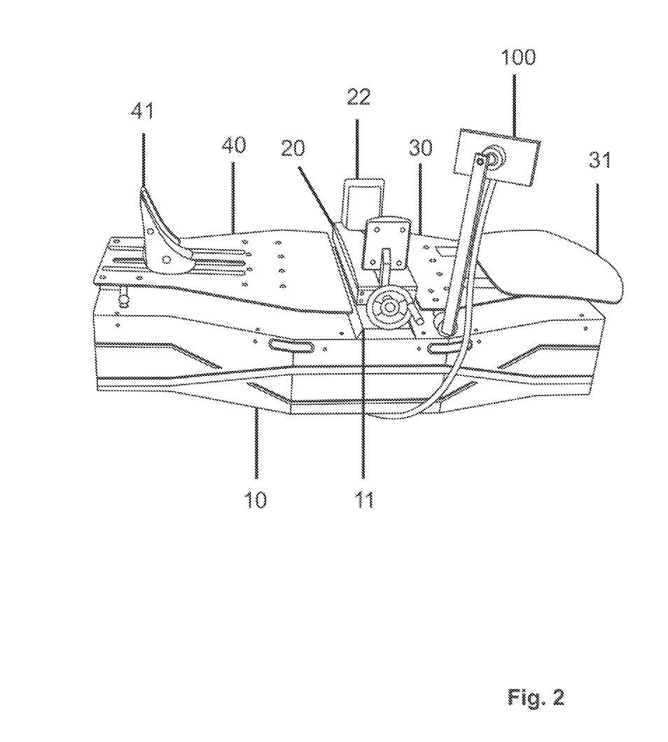

### DETAILED DESCRIPTION OF THE INVENTION

The device for passive body mobilization, object of the present invention, comprises a base (10) that has on the upper face a bipartite structure for placing an individual lying down, said device presents a motor unit controlled by a Programmable Logic Controller (PLC) (100).

The bipartite structure comprises an oblong-shaped body that has a region of discontinuity placed in a transverse central area where a movable platform (20) is disposed for placing the user's hip, an area on one of the ends (30) for placing the head, chest and abdomen and a second area on the opposite end (40) for placing the lower limbs.

The first area (30) and the second area (40) present a mechanism that allows for adjusting the height or the surface inclination of said areas (30 and (40), said mechanism that can include a manual adjustment as a lever or an automatic adjustment activated by the PLC.

The first area (30) preferably has a support (31) for the user's head, so as to avoid an involuntary motion.

The second area (40) preferably has a support (41) for fixing the user's feet, said support (41) that has means for adjusting the position in said second area (40).

The movable platform (20) comprises a structure placed in linear guides (11) disposed on the base (10), said movable platform (20) performs a movement on the horizontal plane between the sides of the base (10) when activated by a frequency inverter (not shown).

On the sides of the movable platform (20) guides (21) are placed which allow for adjusting the distance between the side plates (22) that immobilize the user's hip.

Optionally, the movable platform (20) has a means for adjusting height (23) so as to be level or unlevel to the first (30) and second areas (40).

The user preferably lays down on his back on the bipartite structure, so as to keep his hip supported on the movable platform (20), with the side plates (22) being adjusted to be near the user's body.

After having the head and feet placed on the respective supports (31) and (41), the device is activated on the PLC dashboard (100), for the movable platform (20) to move horizontally in previously set cycles in order to displace the body's axis.

1. A device for Passive Body Mobilization comprising a base (10) with a motor unit controlled by a Programmable Logic controller (PLC) (100), characterized in that the base (10) has on the upper face an oblong bipartite structure having a region of discontinuity located at the transverse central area where a movable platform (20) is disposed for placing the user's hip comprising a structure positioned in linear guides (11) arranged on the base (10), said platform (20) which performs a horizontal movement between the sides of the base (10) as a result of the action of a frequency inverter (not shown) and the sides of the movable platform (20) equipped with guides (21) which allow the distance of the side plates (22) that immobilize the user's hip to be adjusted, a first area on one of the ends (30) of the bipartite structure for placing the head, chest and abdomen, and the second area on the opposite end (40) of the bipartite structure for placing the lower limbs, with the first area (30) and the second area (40) presenting a mechanism allowing the height and surface inclination of said areas (30) and (40) to be adjusted.

2. A device for Passive Body Mobilization, according to claim 1, characterized in that the first area (30) and the second area (40) have a manual adjustment mechanism using a lever or automatic adjustment activated by the PLC.

3. A device for Passive Body Mobilization, according to claim 1, characterized in that preferably the first area (30) has a support (31) for the user's head.

4. A device for Passive Body Mobilization, according to claim 1, characterized in that preferably the second area (40) has a support (41) for fixing the user's feet.

5. A device for Passive Body Mobilization, according to claim 1, characterized in that optionally the movable platform (20) has means for height adjustment (23).
